(19) United States
(12) Patent Application Publication
(10) Pub. No.: US 2007/0197096 A1
(43) Pub. Date: Aug. 23, 2007

(54) Electrical connector having improved conductive shell

(75) Inventors: Guo-Jina Shen, Kunshan (CN); Chi Zhang, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/708,719

(22) Filed: Feb. 20, 2007

(30) Foreign Application Priority Data
Feb. 21, 2006 (CN) 200620069564.1

(51) Int. Cl. H01R 13/648

(52) U.S. Cl. 439/609

(57) ABSTRACT

An electrical connector includes an insulated housing (10) comprising an upper wall (110) and a lower wall (111) which cooperating to define a mating slot (170) therebetween; and a conductive shell (20) comprising an upper shielding wall (21) for shielding the upper wall, a lower shielding wall (22) for shielding the lower wall and a pair of joining portions (23) connecting lengthwise ends of front edges of the upper and lower shielding walls together; and a pair of bend portions integrally provided on the shell including an upper bend portion (261) and a lower bend portion (262) respectively extending the front edges of the upper and lower shielding walls. The bend portions are arranged to space clearances (27) to the joining portions, the clearances respectively extend from the mating slot toward the upper and lower shielding walls till the bend portion is separated from the joining portions absolutely.

### BACKGROUND OF THE INVENTION

1. Field of the Invention

The present invention is related with an electrical connector, and more particularly to an electrical connector having a conductive shell.

2. Description of Related Art

Electrical connectors are widely used in Notebooks, Cellular Phones and the other like electronic devices. Referring to FIG. 6, a conventional electrical connector 100′ disclosed by Taiwan Patent Issued Number M273838 is provided. The connector 100′ comprises an insulated housing 10′, a plurality of conductive terminals 20′ and a conductive shell 20′. The housing 10′ is a rectangular case comprising a rear base, an upper wall, a lower wall, and a pair of lateral walls, all of which cooperate to define a mating slot 110′ for receiving a complementary connector. The shell 20′ is a rectangular annularity comprising an upper shielding wall 31′, a lower shielding wall 32′, and a pair of joining portions 33′ respectively for shielding the upper wall, the lower wall and front surfaces of lateral walls of the housing 10′. A pair of bend portions 310′ which are provided on the shell 20′ include an upper bend portion and a lower bend portion respectively extending from front edges of the upper shielding wall along a thickness direction of the housing 10′.

However, the bend portions 310′ hardly obtain a flat surface during punch process due to the small lengths of the bend portions 310′ along the thickness direction. Moreover, the bend portions 310′ are constructed by punch in company with the joining portions 33′ as they are integrally connecting with each other to be located at the same side of housing 10′, and inducing the joining portions 33′ are easily distorted during punch process.

Thus it is desired to provide an electrical connector with a wonderful performance conductive shell.

### SUMMARY OF THE INVENTION

An object of the present invention is to provide an electrical connector with a wonderful performance conductive shell which can be easily constructed by punch.

In order to achieve above-mentioned objects, an electrical connector of the present invention includes a longitudinal housing comprising an upper wall, a lower wall and a pair of lateral walls, all of which cooperating to define a mating slot therebetween; a plurality of conductive terminals loaded in the housing; a conductive shell comprising an upper shielding wall for shielding the upper wall, a lower shielding wall for shielding the lower wall and a pair of joining portions connecting lengthwise ends of front edges of the upper shielding wall and the lower shielding wall together; and a pair of bend portions which are integrally provided on the shell including an upper bend portion extending and a lower bend portion respectively extending the front edge of the upper shielding wall and the front edge of the lower shielding wall, and at least one bend portion arranged to space clearances to the joining portions, the clearances respectively extending from the mating slot toward one of the upper shielding wall and the lower shielding wall till the bend portion is separated from the joining portions absolutely.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled perspective view of an electrical connector in accordance with the present invention;

FIG. 2 is a similar view to FIG. 1, but taken from another aspect;

FIG. 3 is an exploded perspective view of the electrical connector;

FIG. 4 is an enlarged view of a circled portion of a conductive shell shown in FIG. 3;

FIG. 5 is a perspective view of an alternative conductive shell of the electrical connector; and

FIG. 6 is an assembled perspective view of a conventional connector.

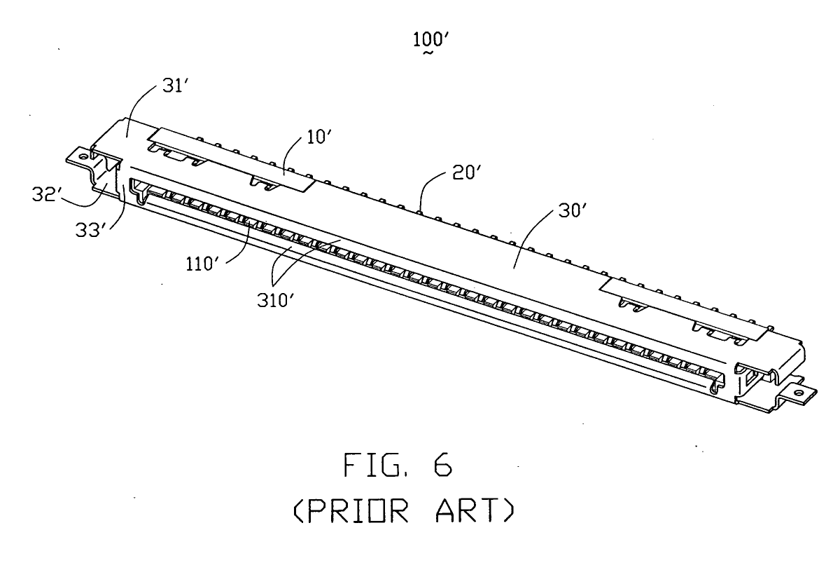

### DETAILED DESCRIPTION OF THE INVENTION

Reference will now be made to the drawing figures to describe the preferred embodiment of the present invention in detail.

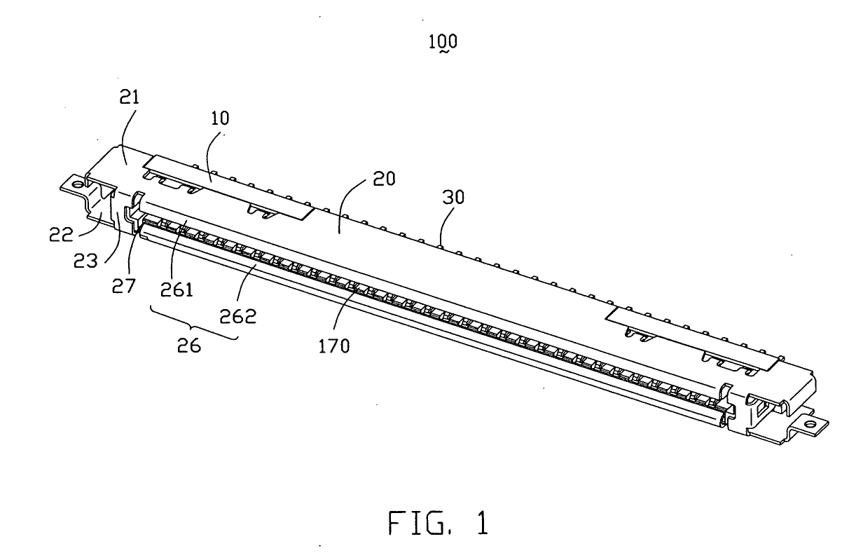

Referring to FIGS. 1 to 3, an electrical connector 100 in accordance with the present invention includes a longitudinal housing 10, a plurality of signal terminals 30, a pair of grounding terminals 31, a plurality of elastic terminals 40, and a conductive shell 20.

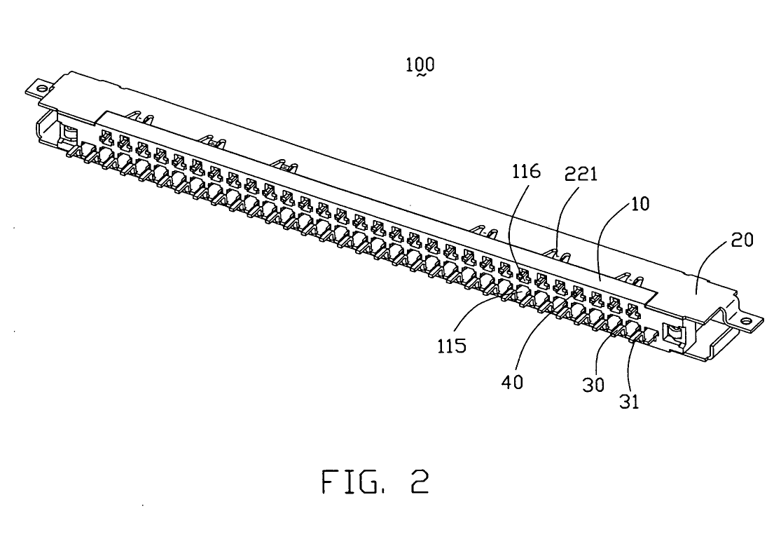

The housing 10 is a rectangular case comprising a rear base 112, an upper wall 110, a lower wall 111, and a pair of lateral walls, all of which cooperate to define a mating slot 170 therebetween for receiving a mating portion of a complementary connector (not shown). The upper wall 110 defines a row of upper channels 113 on its inner face that is adjacent to the mating slot 170 for accommodating the signal terminals 30, and the lower wall 111 defines a row of lower channels 114 also on an inner face thereof for accommodating the elastic terminals 40. Both the upper channels 113 and the lower channels 114 run along a front-to-back direction that is an insertion direction of the complementary connector and extend throughout the rear base 112 (shown in FIG. 2). Further, at longitudinal ends of the row of upper channels 113 are a pair of side upper channels for accommodating the grounding terminals 31 which are respectively defined through the rear base 112.

Concerning the terminals 30, 31, 40, the signal terminals 30 and the grounding terminals 31 are punched from the same metal sheet and thus are arranged in a row wherein that two terminals positioned in longitudinal ends of the row are the grounding terminals 31 and the others are the signal terminals 30. The row terminals, including the signal terminals 30 and the grounding terminals 31 are respectively and correspondingly inserted into the upper channels 113 and the side upper channels and have tail portions for soldering a printed circuit board (PCB) which are easily arranged to be coplanar with each other. The elastic terminals 40 are assembled to the housing 10 to be correspondingly accommodated in the lower channels 114 and thus arranged in a second row that oppose to the row of the signal terminals 30 and the grounding terminals 31. The signal terminals 30 and the elastic terminals 40 all have resilient contact portion projecting into the mating slot 170.

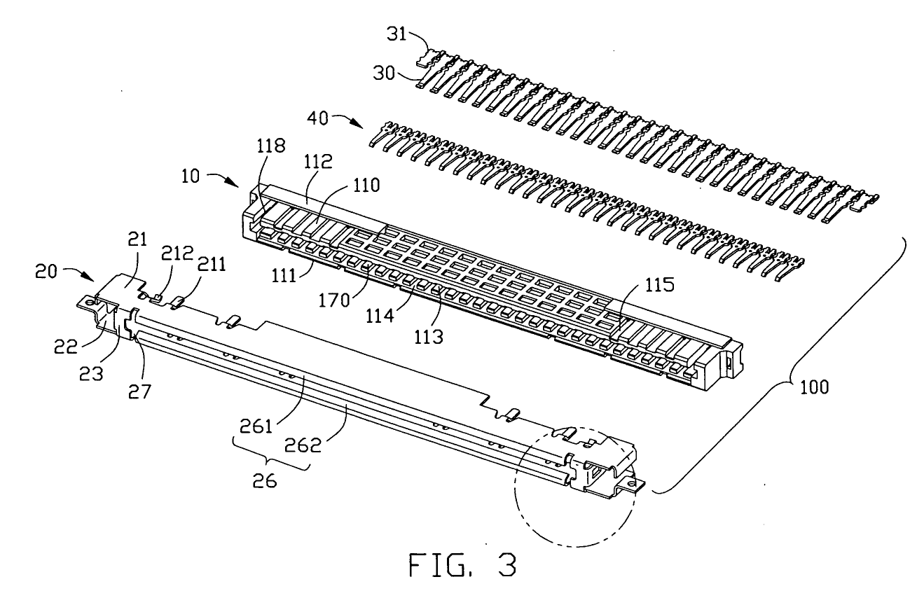

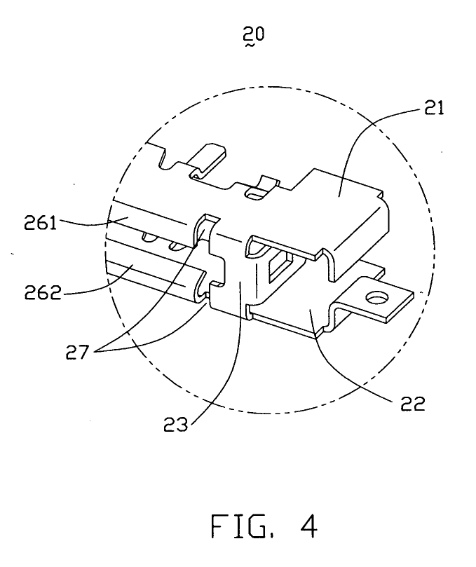

Referring to FIGS. 3 and 4, the conductive shell 20 is a rectangular annularity comprising an upper shielding wall 21, a lower shielding wall 22, and a pair of joining portions 23 respectively for shielding the upper wall 110, the lower wall 111 and front surfaces of lateral walls of the housing 10. For being reliably attached to the housing 10, the shell 20 is formed with retaining tabs 211 and 221 integrally extending rearwards from its upper shielding wall 21 and lower shielding wall 22 respectively. Correspondingly, for guiding and retaining the retaining tabs 211 and 221, the housing 10 defines grooves 115 and 116 (shown in FIG. 2) respectively on outer surfaces of its upper wall 110 and lower wall 111. The grooves 115 and 116 run along the front-to-back direction and extend through the rear base 112, wherein the grooves 116 on the lower wall 111 come into communication with the lower channels 114 in the rear base 112. When the retaining tabs 211 and 221 slide along the grooves 115 and 116 respectively, and enter into the rear base 112 to be retained therein, the retaining tabs 221 come into contact with the elastic terminals 40 in the rear base 112. In addition, the shell 20 has a pair of elastic tab 212 extending rearwards and downwards from the upper shielding wall 21 thereof for correspondingly contacting the grounding terminals 31 respectively. A pair of cutouts 118, which communicate with the mating slot 100, are defined in the upper wall 11 at the positions corresponding to the grounding terminals 31 for allowing the elastic tabs 212 to extend into the side upper channels to contact the grounding terminals 31. As the shell 20 contacts both the elastic terminals 40 and the grounding terminals 31, a grounding path from the elastic terminals 40 to the shell 20 then to the grounding terminals 31 and finally to the PCB is established.

A pair of bend portions 26, integrally provided on the shell 20, includes an upper bend portion 261 extending downward from a front edge of the upper shielding wall 21 for shielding a front surface of the upper wall 110 and a lower bend portion 262 extending upward from a front edge of the lower shielding wall 22 for shielding a front surface of the lower wall 111, and then projecting into the mating slot 170 for guiding the complementary connector being inserted. It is noted that the bend portions 26 are arranged to set clearances 27 to the two joining portions 23, and the clearances 27 respectively extend from distal edges of bend portions 26 through to the upper shielding wall 21 and the lower shielding wall 22 so that the bend portions 26 are separated from the joining portions 23 absolutely. As setting the clearances 27, the bend portions 26 and the joining portions 23 can be respectively constructed by punching so as to avoid unexpected distortions taking place, and thereby achieve a wonderful performance.

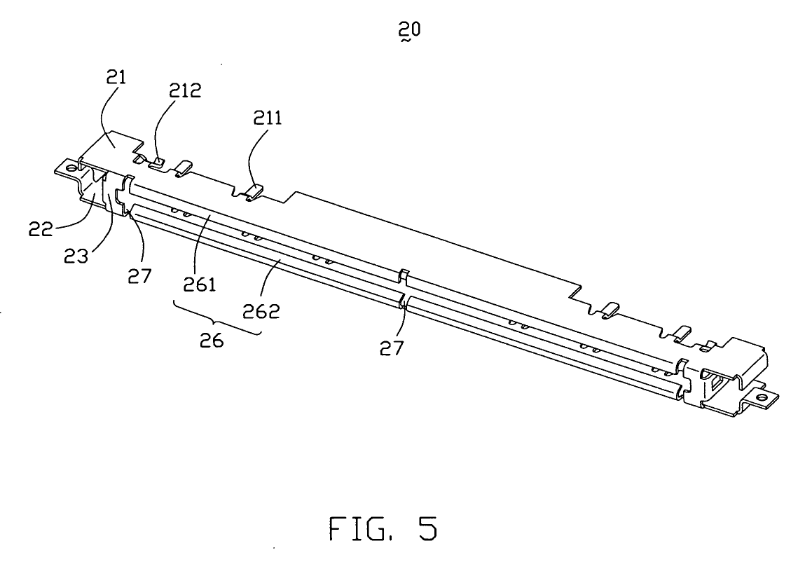

However, the disclosure is illustrative only, changes may be made in detail, especially in matter of shape, size, and arrangement of parts within the principles of the invention. For example, the bend portions 26 can define a plurality of gaps thereon for further prevent distortions taking place (shown in FIG. 5). If the upper bend portion 261 extends downward with an enough width from the front edge of the upper shielding wall 21.

What is claimed is:

1. An electrical connector comprising:
a longitudinal housing comprising an upper wall and a lower wall both of which cooperating to define a mating slot therebetween;
a plurality of conductive terminals loaded in the housing;
a conductive shell comprising an upper shielding wall for shielding the upper wall, a lower shielding wall for shielding the lower wall and a pair of joining portions connecting lengthwise ends of front edges of the upper shielding wall and the lower shielding wall together; and
a pair of bend portions which are integrally provided on the shell including an upper bend portion extending and a lower bend portion respectively extending the front edge of the upper shielding wall and the front edge of the lower shielding wall, and at least one bend portion arranged to space clearances to the joining portions, the clearances respectively extending from the mating slot toward one of the upper shielding wall and the lower shielding wall till the bend portion separated from the joining portions absolutely.

2. The electrical connector as claimed in claim 1, wherein the lower bend portion projects into the mating slot.

3. The electrical connector as claimed in claim 1, wherein the bend portions define at least one gap thereon.

4. The electrical connector as claimed in claim 1, wherein clearances are split from distal edges of the bend portions through to the upper shielding wall and the lower shielding wall.

5. An electrical connector assembly comprising:
an insulative housing defining a lengthwise direction with an elongated mating cavity extending rearward from a front face thereof along said lengthwise direction;
a plurality of contacts disposed in the housing and extending into the mating cavity; and
a metallic shell enclosing said housing and forming a bent flange along a long front edge of the housing in said lengthwise direction and proximate a front opening of said mating cavity; wherein
a pair of rearwardly extending cutouts are formed at two opposite ends of said bent flange.

6. The connector assembly as claimed in claim 5, wherein said flange is further bent rearwardly and invades the mating cavity.
